(19) United States
(12) Patent Application Publication
(10) Pub. No.: US 2025/0379673 A1
(43) Pub. Date: Dec. 11, 2025

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Wei CHEN, Beijing (CN); Junjie WU, Beijing (CN); Ce ZHENG, Beijing (CN); Xiaoxue WANG, Beijing (CN); Chen SUN, Beijing (CN)

(73) Assignee: Sony Group Corporation, Tokyo (JP)

(21) Appl. No.: 18/880,849

(22) PCT Filed: Jul. 5, 2023
(86) PCT No.: PCT/CN2023/105811

§ 371 Date: Jan. 3, 2025

(30) Foreign Application Priority Data
Jul. 11, 2022 (CN) 202210809772.4

(51) Int. Cl. H04B 17/391; G06N 20/00; H04W 24/10; H04W 92/18

(52) U.S. Cl. CPC H04B 17/3913; G06N 20/00; H04W 24/10; H04W 92/18

(57) ABSTRACT

The present application relates to an electronic device and method for wireless communication, and a computer-readable storage medium. The electronic device for wireless communication comprises a processing circuit, wherein the processing circuit is configured to: on the basis of channel information of the channel state of at least one sidelink related to at least one user equipment, which channel information is reported by means of the at least one user equipment located within the service range of the electronic device, divide into at least one group learning models of user equipment related to the at least one sidelink, and for at least some groups among the at least one group, perform joint training on the learning models in the same group.

This application claims priority to Chinese Patent Application No. 202210809772.4 titled “ELECTRONIC DEVICE AND METHOD FOR WIRELESS COMMUNICATION, AND COMPUTER-READABLE STORAGE MEDIUM”, filed on Jul. 11, 2022 with the China National Intellectual Property Administration (CNIPA), which is incorporated herein by reference in its entirety.

### FIELD

The present disclosure relates to the technical field of wireless communication, and in particular to an electronic apparatus and method for wireless communication and a computer-readable storage medium. More specifically, the present disclosure involves grouping learning models of user equipment related to sidelinks, and performing joint training on learning models which are in a same group.

### BACKGROUND

With the development of wireless networks and artificial intelligence, networks are in a trend of becoming intelligent. Especially for future 6G, wireless network intelligence is an important direction for its development. More specifically, Federated Learning (FL) is currently the most important distributed artificial intelligence framework. A combination of the federated learning with the wireless networks is one of the main contents of intelligent applications of wireless networks in the future. Therefore, how to effectively realize a joint design of the FL and the current 5G NR has an important impact on future artificial intelligence applications. In particular, in highly intelligent wireless networks, how to effectively use FL to perform joint training on machine learning models in the intelligent wireless networks based on characteristics of wireless communication is attracting more and more widespread attention.

During an evolution of the wireless networks, various machine learning models may be used for optimizing network decision-making and operation. For example, communication between vehicles (V2V) in the Internet of Vehicles is realized by a sidelink. In most cases, it can be modeled as a Markov Decision Process (MDP), solved by using deep reinforcement learning (DRP).

How to effectively utilize the FL to perform the joint training for the sidelink is a hot topic in current researches.

### SUMMARY

A brief summary of the present disclosure is given below, to provide a basic understanding of some aspects of the present disclosure. It should be understood that the following summary is not an exhaustive summary of the present disclosure. It is not intended to determine a key or important part of the present disclosure, nor does it intend to limit the scope of the present disclosure. Its objective is merely to present some concepts in a simplified form, which serves as a preamble of a more detailed description to be discussed later.

According to an aspect of the present disclosure, an electronic apparatus for wireless communication is provided. The electronic apparatus includes a processing circuitry, configured to: divide, based on channel information about channel state of at least one sidelink of at least one user equipment located within service range of the electronic apparatus, learning models of the user equipment related to the at least one sidelink into at least one group, where the channel information is reported by the at least one user equipment; and perform, for at least part of the at least one group, joint training on the learning models which are in a same group.

In embodiments of the present disclosure, the electronic apparatus solves a data heterogeneity problem caused by different environments of a sidelink through grouping, so that an efficiency of a joint training is improved, and a quality of learning models and a system performance are improved.

According to an aspect of the present disclosure, an electronic apparatus for wireless communication is provided. The electronic apparatus includes a processing circuitry, configured to report, to a network-side apparatus serving the electronic apparatus, channel information about channel state of at least one sidelink of the electronic apparatus, for the network-side apparatus to: divide, based on the channel information, learning models of the electronic apparatus related to the at least one sidelink and learning models of other electronic apparatuses served by the network-side apparatus and related to the at least one sidelink into at least one group, so as to perform, for at least part of the at least one group, joint training on the learning models which are in a same group.

In embodiments of the present disclosure, the electronic apparatus reports the channel information about the channel state of the sidelink to the network-side apparatus, so that the network-side apparatus groups the learning models of the electronic apparatus related to the sidelink based on the channel information. In this way, the network-side apparatus is enabled to solve a data heterogeneity problem caused by different environments of a sidelink through grouping, so that an efficiency of a joint training is improved, and a quality of learning models and a system performance are improved.

According to an aspect of the present disclosure, a method for wireless communication is provided. The method includes: dividing, based on channel information about channel state of at least one sidelink of at least one user equipment located within service range of an electronic apparatus, learning models of the user equipment related to the at least one sidelink into at least one group, where the channel information is reported by the at least one user equipment; and performing, for at least part of the at least one group, joint training on the learning models which are in a same group.

According to an aspect of the present disclosure, a method for wireless communication is provided. The method includes: reporting, to a network-side apparatus serving an electronic apparatus, channel information about channel state of at least one sidelink of the electronic apparatus, for the network-side apparatus to: divide, based on the channel information, learning models of the electronic apparatus related to the at least one sidelink and learning models of other electronic apparatuses served by the network-side apparatus and related to the at least one sidelink into at least one group, so as to perform, for at least part of the at least one group, joint training on the learning models which are in a same group.

According to other aspects of the present disclosure, there are further provided a computer program code and a computer program product for implementing the above-described methods for wireless communication, and a computer-readable storage medium having the computer program code for implementing the methods for wireless communication recorded thereon.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 shows a block diagram of functional modules of an electronic apparatus for wireless communication according to an embodiment of the present disclosure;

FIG. 2 is a schematic diagram showing a system structure according to an embodiment of the present disclosure;

FIG. 3 is a schematic diagram illustrating a sidelink power & rate adaptive control scenario according to an embodiment of the present disclosure;

FIG. 4a and FIG. 4b are schematic diagrams illustrating a division based on a degree of similarity between probability distributions of channel energy gains of sidelinks according to an embodiment of the present disclosure;

FIG. 5 is an example diagram illustrating information interaction between an electronic apparatus and user equipment according to an embodiment of the present disclosure;

FIG. 6 shows a block diagram of functional modules of an electronic apparatus for wireless communication according to another embodiment of the present disclosure;

FIG. 7 shows a flow chart of a method for wireless communication according to an embodiment of the present disclosure;

FIG. 8 shows a flow chart of a method for wireless communication according to another embodiment of the present disclosure;

FIG. 9 is a block diagram showing a first example of a schematic configuration of an eNB or gNB to which the technology of the present disclosure can be applied;

FIG. 10 is a block diagram showing a second example of a schematic configuration of an eNB or gNB to which the technology of the present disclosure can be applied;

FIG. 11 is a block diagram showing an example of a schematic configuration of a smart phone to which the technology of the present disclosure can be applied;

FIG. 12 is a block diagram showing an example of a schematic configuration of an automobile navigation device to which the technology of the present disclosure can be applied; and

FIG. 13 is a block diagram of an exemplary structure of a universal personal computer in which the methods and/or apparatuses and/or systems according to the embodiments of the present disclosure can be implemented.

### DETAILED DESCRIPTION

Hereinafter, exemplary embodiments of the present disclosure will be described in conjunction with the accompanying drawings. For the sake of clarity and conciseness, not all features of an actual embodiment are described in the specification. However, it is to be appreciated that numerous implementation-specific decisions shall be made during developing any of such actual implementations so as to achieve specific objectives of a developer, for example, to comply with system- and business-related constraining conditions which will vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

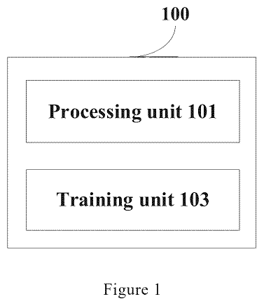

FIG. 1 shows a block diagram of functional modules of an electronic apparatus 100 for wireless communication according to an embodiment of the present disclosure.

As shown in FIG. 1, the electronic apparatus 100 includes a processing unit 101 and a training unit 103. The processing unit is configured to divide, based on channel information about channel state of at least one sidelink of at least one user equipment located within service range of the electronic apparatus, learning models of the user equipment related to the at least one sidelink into at least one group, where the channel information is reported by the at least one user equipment. The training unit 103 is configured to perform, for at least part of the at least one group, joint training on the learning models which are in a same group.

The processing unit 101 and the training unit 103 may be implemented by one or more processing circuits. The processing circuitry may be implemented as a chip, for example.

The electronic apparatus 100 may serve as a network-side apparatus in a wireless communication system, and may be specifically provided on a base station side or be communicatively connected to a base station, for example. Here, it should be noted that the electronic apparatus 100 may be implemented at a chip level or at an apparatus level. For example, the electronic apparatus 100 may operate as the base station itself and may further include a memory, a transceiver (not shown), and other external devices. The memory may store related data information and programs that the base station needs to execute to achieve various functions. The transceiver may include one or more communication interfaces to support communication with different devices (such as user equipment (UE), another base station, and the like). An implementation of the transceiver is not specifically limited here.

The base station may be an eNB or gNB, as an example.

For example, the electronic apparatus 100 may be connected to a core network.

The wireless communication system according to the present disclosure may be a 5G NR (New Radio) communication system. Further, the wireless communication system according to the present disclosure may include a non-terrestrial network (NTN). Alternatively, the wireless communication system according to the present disclosure may further include a terrestrial network (TN). In addition, those skilled in the art can understand that the wireless communication system according to the present disclosure may be a 4G or 3G communication system.

For example, the user equipment may be user equipment for transmitting on the sidelink (SL) (referred to as transmitting user equipment) or user equipment for receiving on the sidelink (referred to as receiving user equipment). The user equipment is capable of perform sidelink control.

In the electronic apparatus 100 according to an embodiment of the present disclosure, federated learning is applied for joint training on the learning models under multi-user equipment condition.

As an example, the learning model may be a traditional machine learning model or deep reinforcement learning model. In the following, the learning model is sometimes described as a deep reinforcement learning model as an example, for convenience.

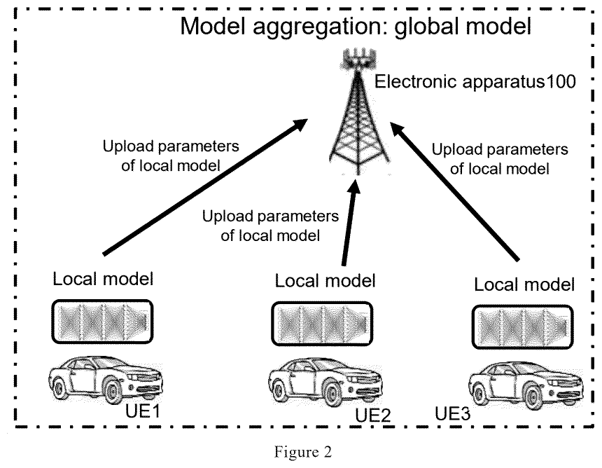

FIG. 2 is a schematic diagram showing a system structure according to an embodiment of the present disclosure.

As shown in FIG. 2, for simplicity, the user equipment is shown as a vehicle. Those skilled in the art can understand that the user equipment may be in other forms besides vehicles. For example, the user equipment may be a terminal device such as a mobile phone, an iPad, and a notebook, as long as there is a sidelink between user equipment. A single user device performs reinforcement learning on a learning model (which may be called a local model) related to its sidelink. For example, the local model is obtained based on the initial global model delivered by the electronic device 100. The electronic apparatus 100 divides the local models on the user equipment into different groups based on the channel information about the channel state of the sidelink of the user equipment (for example, only three user equipment UE1, UE2 and UE3 which are located in a same group are shown in FIG. 2, for simplicity). The user equipment uploads parameters of its local model to the electronic apparatus 100. For the user equipment UE1, UE2 and UE3 in a same group, the electronic apparatus 100 performs the joint training on the learning models (aggregation of the learning models) through federated learning, to form a global model.

For joint training of learning models in the conventional technology that does not use federated learning, the quantity of samples used for training and learning is usually insufficient, resulting in difficulty in training of the learning models. Compared with joint training of learning models without using federated learning, the joint training on learning models considering use of the federated learning can overcome the problems of insufficient training samples and slow convergence speed of a single reinforcement learning.

In the federated learning according to a conventional technology, a data heterogeneity problem is caused due to different environments of different equipment. Due to the data heterogeneity, irrelevant samples are added during the aggregation process, resulting in a reduced speed of divergence or convergence of the learning models during the training process, so that a quality of the learning model and a system performance are reduced. In other words, differences in random channel environments results in heterogeneity of data collected between different user equipment, resulting in different degrees of variability in the learning models trained on different sidelinks. Such situation is particularly serious in deep reinforcement learning. The variability leads to a degradation in an overall performance of training based on federated learning in the conventional technology. For example, the problem is even more severe in vehicle-to-everything (V2X). Two main reasons are described below. (1) Due to mobility of a vehicle, devices in V2X face more complex and diverse environments, resulting in intensified heterogeneity of data; (2) Training in V2X requires use of reinforcement learning model in many cases, and application of reinforcement learning requires the apparatus to continuously obtain rewards from the environment. Hence, an impact of diverse environments on system performance is intensified.

In embodiments of the present disclosure, the electronic apparatus 100 solves the data heterogeneity problem caused by different environments of a sidelink through grouping, so that an efficiency of a joint training is improved, and a quality of learning models and a system performance are improved.

As an example, the at least one user equipment is an apparatus in a D2D scenario. For example, the at least one user equipment is a vehicle-mounted device in the Internet of Vehicles. However, the user equipment is not limited to the V2X Internet of Vehicles scenario, and any communication scenario linked by the sidelink may be applied. For example, in a D2D scenario, the communication between user equipment may be mutual communication between terminal devices (mobile phones, tablet computers, etc.). The communication between user equipment may be communication between XR devices in an XR (extended reality) scenario. The communication between user equipment may be communication between devices in an industrial Internet scenario, a smart home appliance scenario, or other scenarios.

Hereinafter, for convenience, the user equipment is a vehicle or a vehicle-mounted device in the Internet of Vehicles as an example for description. Those skilled in the art can understand that the user equipment may be in other forms besides the vehicle-mounted device, as long as there is a sidelink between user equipment.

In V2X, most problems can be modeled as Markov Decision Problem (MDP) problems. Therefore, deep reinforcement learning may be utilized to solve the problem. A specific example is a power & rate adaptive control of sidelink information transmission. Data transmission of vehicle equipment requires the consumption of battery power, and a battery capacity is limited. Therefore, to have a longer battery life, an average power constraint of a transmitting apparatus needs to be given during the data transmission process of the sidelink. However, a wireless channel state between vehicles is random. Therefore, in a case where it only tends to achieve a low energy consumption of information transmission and perform the transmission when a channel condition is good (opportunistic transmission), a data packet may wait in a queue for a long time, causing a serious data queuing delay. Therefore, it is necessary to achieve an optimal delay-power trade-off relationship through an efficient adaptive power control, so as to minimize the data transmission delay while ensuring that an average power consumption requirement is satisfied. Such a power control problem may be modeled as an MDP problem and solved by using deep reinforcement learning.

As an example, the channel information of the sidelink includes at least one of: a probability distribution of a channel energy gain of the sidelink, a Reference Signal Receiving Power (RSRP), a Received Signal Strength Indicator (RSSI), a Reference Signal Receiving Quality (RSRQ), a Signal-to-Noise Ratio (SNR), information about whether user equipment serving as a receiver and user equipment serving as a transmitter related to the sidelink are located within a line-of-sight range, and statistics of interference and noise of channel.

The channel information of sidelink is for measuring a degree of similarity between learning models related to the sidelink. The electronic apparatus 100 groups the learning models of user equipment related to the sidelink based on the channel information of the sidelink, and performs joint training on learning models having a high degree of similarity.

As an example, the processing unit 101 may be configured to divide the leaning models based on a degree of similarity between probability distributions respectively corresponding to the at least one sidelink.

As an example, the channel energy gain is divided into a predetermined number of discrete levels, and the probability distribution includes probabilities that the channel energy gain is at respective levels.

During an evolution of the wireless networks, various machine learning models may be used for optimizing network decision-making and operation. As mentioned above, an example is the power control problem during data transmission: the transmitting vehicle adaptively adjusts, in real time, the data transmission power and the number of data packets sent according to a current channel state between vehicles and a data queue state. The channel state between vehicles is random. Therefore, in a case where it only tends to achieve real-time of information transmission (that is, instant transmission), a power consumption cost is very high under a poor channel state. In a case where it only tends to achieve a low energy consumption of information transmission and perform the transmission when a channel condition is good (that is, opportunistic transmission), a data packet may wait in a queue for a long time, causing a serious data queuing delay. Therefore, it is necessary to achieve an optimal delay-power trade-off relationship through an efficient adaptive power control, so as to minimize the data transmission delay while ensuring that an average power consumption requirement is satisfied.

In order to illustrate the basis of federated learning grouping, the power & rate adaptive control of sidelink is taken as an example for description. For example, the learning model is for assisting in determining a data transmission rate of the sidelink based on a data queue length and a channel energy gain of the sidelink.

For the example where the user equipment is a vehicle, as mentioned above, multiple sidelinks may perform joint training on the learning models through federated learning. However, due to the heterogeneity between different vehicles and the sensitivity of the learning models (especially deep reinforcement learning (DRL) models) to the environment, there are differences of the DRL models trained in different random environments. In the sidelink communication problem, a probability distribution characteristic of wireless channel is the random environment for training. In an embodiment according to the present disclosure, user equipment having similarity of the probability distribution characteristic of wireless channel state (for example, a probability distribution of channel energy gain) are selected for grouping of FL. Hence, vehicles having similar random environments are selected for joint training of federated learning, so that an efficiency of the joint training is improved.

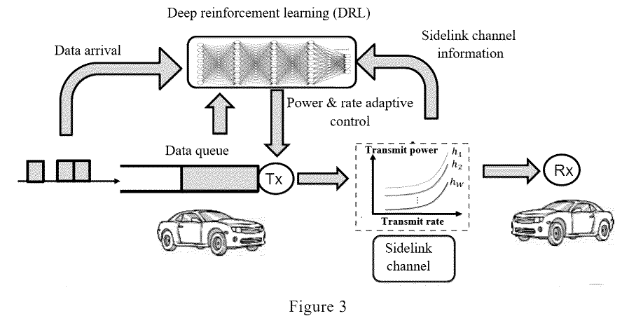

FIG. 3 is a schematic diagram illustrating a sidelink power & rate adaptive control scenario according to an embodiment of the present disclosure. In FIG. 3, Tx represents transmission and Rx represents reception.

With reference to FIG. 3, the user equipment needs to determine a current data transmission rate s and a current data transmission power P based on a current data queue length q (the number of data packets in the queue waiting to be transmitted) and a current channel energy gain level h (the channel energy gain is divided into w discrete levels), where the transmission power P is determined from the transmission rate s and the channel energy gain h, and may be calculated through a channel capacity formula. In this way, it is ensured that the average queuing delay of data transmission in the sidelink is minimized under the constraint of the limited average power consumption. The channel energy gain of the sidelink is independently and identically distributed over transmission time slots. A probability distribution that the channel energy gain on the i-th sidelink obeys is represented as, Pᵢ=[pᵢ(h₁),pᵢ(h₂), . . . , pᵢ(h_{w})], and a probability that the channel energy gain on the i-th sidelink is at the k-th level is represented as pᵢ(hₖ), where 1≤k≤w. How to select an optimal transmission power and transmission rate in real time based on the real-time varying queue length and channel energy gain may be modeled as a Markov decision-making problem. The Markov decision-making problem may be solved by using a deep reinforcement learning model. Specifically, the deep reinforcement learning model fits a value function in a reinforcement learning process through an artificial neural network. In FIG. 3, an input of the artificial neural network includes the queue length q, the channel gain level h, and the transmission rate s; and an output is a value function V(q, h, s) corresponding to a state (q, h, s). According to the value function V(q, h, s) provided by the artificial neural network, the user equipment can obtain the optimal transmission rate s* under the queue length q and the channel gain level h, where s*=argmin, V(q, h, s). Furthermore, in FIG. 3, different artificial neural network models are trained under different probability distributions of channel energy gain.

According to the characteristics of federated learning, sidelinks having similar probability distributions of channel energy gain are grouped to a same federated learning group for training, so that an accuracy of the aggregated global model is improved.

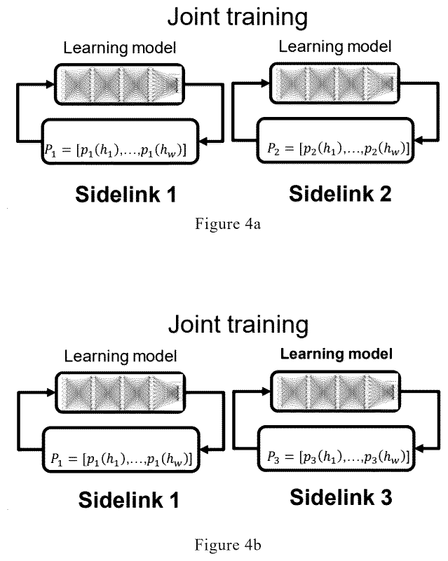

FIG. 4a and FIG. 4b are schematic diagrams illustrating a division based on a degree of similarity between probability distributions of channel energy gains of sidelinks according to an embodiment of the present disclosure.

In FIG. 4a, it is assumed that a probability distribution P₁ of channel energy gain on sidelink 1 is similar to a probability distribution P₂ of channel energy gain on sidelink 2. In this case, grouping the learning model related to sidelink 1 and the learning model related to sidelink 1 into a same group can improve an effect of joint training.

In FIG. 4b, it is assumed that the probability distribution P₁ of channel energy gain on sidelink 1 is not similar to a probability distribution P₃ of channel energy gain on sidelink 3. In this case, grouping the learning model related to sidelink 1 and the learning model related to sidelink 3 into a same group is not conducive to improving the effect of joint training.

As an example, the degree of similarity between probability distributions includes a KL divergence between the probability distributions.

For two probability distributions Pᵢ and Pⱼ of a discrete random variable, that is, Pᵢ=[pᵢ(h₁),pᵢ(h₂), . . . , pᵢ(h_{w})] and Pⱼ=[pⱼ(h₁),pⱼ(h₂), . . . , pⱼ(h_{w})], a KL divergence is defined as:

$${D}_{KL} ( {P}_{i} \vert \vert {P}_{j} ) = {\sum }_{{h}_{k}} {p}_{i} ( {h}_{k} ) log \frac{{p}_{i} ( {h}_{k} )}{{p}_{j} ( {h}_{k} )} \qquad ( Equation 1 )$$

$${D}_{KL} ( {P}_{j} \vert \vert {P}_{i} ) = {\sum }_{{h}_{k}} {p}_{j} ( {h}_{k} ) log \frac{{p}_{j} ( {h}_{k} )}{{p}_{i} ( {h}_{k} )} \qquad ( Equation 2 )$$

Due to asymmetry of the KL divergence, a maximum value Dᵢⱼ=max{D_{KL}(Pᵢ∥Pⱼ), D_{KL}(Pⱼ∥Pᵢ)} is taken for each pair of KL divergences. That is, for each pair of KL divergences expressed by equation 1 and equation 2, the maximum value is expressed as Dᵢⱼ.

Then, a minimum KL divergence is selected from maximum values taken for pairs of KL divergences. Based on this, user equipment having the minimum KL divergence are grouped into a same group.

For example, there are 4 user equipment and 6 sidelinks, and 3 user equipment are selected therefrom and grouped. The corresponding KL divergence is assumed as:

$${D}_{KL} ( {P}_{1} \vert \vert {P}_{2} ) = 0.5 ; \qquad {D}_{KL} ( {P}_{2} \vert \vert {P}_{1} ) = 0.6 ;$$

$${D}_{KL} ( {P}_{1} \vert \vert {P}_{3} ) = 0.7 ; \qquad {D}_{KL} ( {P}_{3} \vert \vert {P}_{1} ) = 0.6 ;$$

$${D}_{KL} ( {P}_{1} \vert \vert {P}_{4} ) = 0.5 ; \qquad {D}_{KL} ( {P}_{4} \vert \vert {P}_{1} ) = 0.4 ;$$

$${D}_{KL} ( {P}_{2} \vert \vert {P}_{3} ) = 0.4 ; \qquad {D}_{KL} ( {P}_{2} \vert \vert {P}_{3} ) = 0.3 ;$$

$${D}_{KL} ( {P}_{2} \vert \vert {P}_{4} ) = 1. ; \qquad {D}_{KL} ( {P}_{4} \vert \vert {P}_{2} ) = 0.8 ;$$

$${D}_{KL} ( {P}_{3} \vert \vert {P}_{4} ) = 0.3 ; \qquad {D}_{KL} ( {P}_{4} \vert \vert {P}_{3} ) = 0.2 ;$$

First, the maximum values selected from the pairs of KL divergences are: D₁₂=0.6; D₁₃=0.7; D₁₄=0.5: D₂₂=0.4; D₂₄=1.0; D₃₄=0.3.

Then, the minimum value Das corresponding to D_{KL}(P₃∥P₄) is selected from these 6 maximum values.

Finally, user equipment corresponding to two minimum values among D_{KL}(P₁∥P₄)=0.5, D_{KL}(P₂∥P₄)=0.4 and D_{KL}(P₃∥P₄) are selected, that is, user equipment 2, user equipment 3 and user equipment 4 are grouped together.

In addition to the above examples, those skilled in the art may envisage other implementations of the division based on the KL divergence, which are not described in detail here.

A smaller value of the KL divergence indicates that two probability distributions are close to each other. A channel state probability distribution with a high degree of similarity represents a reinforcement learning model with a high degree of similarity. Reinforcement learning models with a high degree of similarity are grouped together for joint training to achieve a better effect of the joint training.

In addition to the KL divergence, those skilled in the art may envisage other examples of the degree of similarity between the probability distributions, which are not described in detail here.

As an example, the processing unit 101 may be configured to divide the leaning models based on a magnitude of the RSRP. For example, learning models of user equipment whose RSRP amplitude is greater than a predetermined threshold may be divided into a same group, and learning models of user equipment whose RSRP amplitude is less than or equal to the predetermined threshold may be divided into another group. Alternatively, the learning models of the user equipment are divided into multiple groups based on the amplitude of the RSRP.

As an example, the processing unit 101 may be configured to divide the leaning models based on a magnitude of the RSSI. For example, learning models of user equipment whose RSSI amplitude is greater than a predetermined threshold may be divided into a same group, and learning models of user equipment whose RSSI amplitude is less than or equal to the predetermined threshold may be divided into another group. Alternatively, the learning models of the user equipment are divided into multiple groups based on the amplitude of the RSSI.

As an example, the processing unit 101 may be configured to divide the leaning models based on a magnitude of the RSRQ. For example, learning models of user equipment whose RSRQ amplitude is greater than a predetermined threshold may be divided into a same group, and learning models of user equipment whose RSRQ amplitude is less than or equal to the predetermined threshold may be divided into another group. Alternatively, the learning models of the user equipment are divided into multiple groups based on the amplitude of the RSRQ.

As an example, the processing unit 101 may be configured to divide the leaning models based on a magnitude of the SNR. For example, learning models of user equipment whose SNR amplitude is greater than a predetermined threshold may be divided into a same group, and learning models of user equipment whose SNR amplitude is less than or equal to the predetermined threshold may be divided into another group. Alternatively, the learning models of the user equipment are divided into multiple groups based on the amplitude of the SNR.

As an example, the processing unit 101 may be configured to divide the leaning models according to whether the user equipment serving as a receiver and the user equipment serving as a transmitter of the sidelink are located within a line-of-sight (LOS) range. For example, if joint training is to be performed on several transmitting user equipment, for transmitting user equipment and corresponding receiving user equipment that are within the line-of-sight range, the transmitting user equipment are divided into a same group; and for transmitting user equipment and corresponding receiving user equipment that are in a non-line-of-sight (NLOS) range, the transmitting user equipment are divided into another group.

As an example, the processing unit 101 may be configured to divide the leaning models based on a magnitude of the statistics of interference and noise of channel.

As an example, the statistics of interference and noise of channel includes a mean and/or a variance.

The above description illustrates how the learning models are grouped in a case where the channel information of the sidelink includes one of the following indicators: a probability distribution of a channel energy gain of the sidelink, a RSRP, a RSSI, a RSRQ, a SNR, information about whether user equipment serving as a receiver and user equipment serving as a transmitter related to the sidelink are located within a line-of-sight range, and statistics of interference and noise of channel.

The following description illustrates how the learning models are grouped in a case where the channel information of the sidelink includes at least two of the following indicators: a probability distribution of a channel energy gain of the sidelink, a RSRP, a RSSI, a RSRQ, a SNR, information about whether user equipment serving as a receiver and user equipment serving as a transmitter related to the sidelink are located within a line-of-sight range, and statistics of interference and noise of channel.

For example, the learning models may be grouped based on priorities of the at least two indicators. For example, a priority of an indicator may be set based on experience or an application scenario.

For example, in a case where the at least two indicators include two indicators, the learning models are grouped based on an indicator having a first priority to obtain a first grouping result; and a grouping is then performed on the first grouping result based on an indicator having a second priority, so that a final grouping result is obtained. For example, it is assumed that the two indicators include a first indicator, an RSRP, and a second indicator, a probability distribution of the channel energy gain of the sidelink; and a priority of the first indicator is higher than a priority of the second indicator. In this case, the learning models may be first grouped based on an amplitude of the RSRP (for example, the learning models of user equipment whose amplitude of the RSRP is greater than a predetermined threshold may be divided into a first group, and the learning models of user equipment whose amplitude of the RSRP is less than or equal to the predetermined threshold may be divided into a second group) to obtain a first grouping result (which, for example, includes the first group and the second group). Then, based on a degree of similarity between the probability distributions of the channel energy gain of the sidelink, grouping is further performed on the first group and the second group, respectively. (For example, the learning models having a high degree of similarity in the first group are divided into a first sub-group, and the other learning models in the first sub-group are divided into a second sub-group; the learning models having a high degree of similarity in the second group are divided into a third sub-group, and the other learning models in the second group are divided into a fourth sub-group). Thereby, final groups are obtained (for example, including the first sub-group, the second sub-group, the third sub-group, and the fourth sub-group).

For example, in a case where the at least two indicators include three indicators, the learning models are grouped based on an indicator having a highest priority to obtain a first grouping result; grouping is then performed on the first grouping result based on an indicator having a second priority to obtain a second grouping result; and grouping is finally performed on the second grouping result, based on an indicator having a third priority, so that a final grouping result is obtained. Similarly, the grouping may be performed in a case where the at least two indicators include four indicators or more, which is not described in detail here.

As an example, the processing unit 101 may be configured to receive the channel information of the sidelink via wireless resource control (RRC) signaling.

For example, the RRC signaling may be MeasResultsSL signaling.

| | |
|---|---|
| MeasResultsSL-r16 ::= | SEQUENCE { |
| measResultsListSL-r16 | CHOICE { |
| measResultNR-SL-r16 | MeasResultNR-SL-r16, |

```
  ...
    },
    ...
}
```

| | |
|---|---|
| MeasResultNR-SL-r16 ::= | SEQUENCE { |
| measResultListCBR-NR-r16 | SEQUENCE (SIZE (1.. maxNrofSL-PoolToMeasureNR-r16)) OF |

MeasResultCBR-NR-r16,

| | |
|---|---|
| measResultListPDCS-NR | SEQUENCE (XXXXX) |
| measResultListOther-NR | SEQUENCE (XXXXX) |

...
}

For example, as shown above, signaling “measResultListPDCS-NR” may be added to the MeasResultsSL signaling to transmit the probability distribution Pᵢ=[pᵢ(h₁),pᵢ(h₂), . . . , pᵢ(h_{w})] of channel state, where pᵢ(hₖ) represents a probability that the channel energy gain on the i-th sidelink is at the k-th level. Alternatively, signaling “measResultListOther-NR” may be added to the MeasResultsSL signaling to transmit other channel information of the sidelink, such as an RSRP, RSRQ, RSSI, SNR, LOS, and statistics of interference and noise of channel. Alternatively, the signaling “measResultListPDCS-NR” and “measResultListOther-NR” may be both added to the MeasResultsSL signaling.

For details and standards of MeasResultsSL, reference may be made to the “TS 38.131 Radio Resource Control (RRC) protocol specification”, which is not described in detail here.

As an example, the processing unit 101 may be configured to send information about the division to at least part user equipment of the user equipment related to a sidelink in each group via a physical downlink control channel (PDCCH).

As an example, the processing unit 101 may be configured to send parameters related to an initial global learning model to the at least part user equipment in a first round of the joint training. In this way, the user equipment can perform local training based on the initial global model and obtain a local model.

As an example, the processing unit 101 may be configured to receive auxiliary state information from the at least part user equipment via an uplink, where the auxiliary state information is for uplink resource allocation.

Within a same federated learning group, the user equipment itself has a large difference in the state. Therefore, after the grouping is completed, the user equipment uploads the auxiliary state information to the electronic apparatus 100 for uplink resource allocation.

As an example, the auxiliary state information includes at least one of a quantity of samples used by the user equipment for training the learning models, location information of the user equipment, moving speed of the user equipment, computing capability of the user equipment, and CPU occupancy rate of the user equipment.

As an example, the processing unit 101 may be configured to perform the uplink resource allocation for the at least part user equipment based on the auxiliary state information. That is, the electronic apparatus 100 obtains available wireless resource block information to prepare for local model upload of federated learning.

The electronic apparatus 100 performs the uplink resource allocation according to the auxiliary state information uploaded by the user equipment in the group. Hence, the Straggler problem can be solved or alleviated, so that the FL process is sped up and the system performance is improved.

Main manifestations of Straggler are that the user equipment has the following factors: 1) a large amount of data: having a larger weight in the aggregation process; 2) a higher priority; 3) a poor computing power or high CPU occupancy rate; and 4) a far distance from the electronic apparatus 100 or a poor channel quality, resulting in a long transmission time or a low transmission rate.

The electronic apparatus 100 allocates more frequency resources to user equipment with the Straggler problem, so that a transmission delay can be reduced and a convergence process of the learning models is accelerated.

As an example, the number of samples used by the user equipment for training the learning model is the number of samples used by the user equipment for training the local model in each iteration of the federated learning iterative training process. According to information of the number of samples used by the user equipment for training the local model, an importance of the local model trained by the user equipment is determined and used to determine uplink wireless resource allocation in the federated learning process.

As an example, the computing capability of the user equipment used for training the local model is a CPU computing speed, and the CPU occupancy rate of the user equipment is a CPU occupancy rate in the training process of the local model. For example, the CPU occupancy rate information for local model training is used for estimating a computing power of the user equipment during the federated learning process and thereby determining the Straggler problem.

Compared with the case where the location information of the user equipment is not considered (that is, distance information between the user equipment and the electronic apparatus 100 is not utilized) and the CPU usage of the local model training is not considered, such information is considered in the present disclosure to determine the Straggler problem in the federated learning process, so that a time required for an iteration is reduced.

As an example, the processing unit 101 may be configured to send information about uplink resource allocation to the at least part user equipment via a downlink.

As an example, the training unit 103 may be configured to receive parameters which are related to a local learning model and which are uploaded by the at least part user equipment based on the information about uplink resource allocation, where the local learning model is trained based on the initial global learning model issued by the electronic apparatus 100.

As an example, the joint training includes aggregating local learning models related to the sidelinks in a same group, as an updated global learning model, to obtain an aggregated learning model. For example, the aggregation is to perform weighted average of parameters of local learning models related to sidelinks within a same group. For example, a base station of the electronic apparatus 100 determines the importance of the uploaded reinforcement learning model based on the information on the number of training samples used when training the local reinforcement learning model for each sidelink; determine, from the importance, a weighting coefficient of the local model during aggregation. In this way, a more accurate global model is obtained from aggregation during the current round of iteration. That is, the electronic apparatus 100 may determine the weight of the local model based on the information on the number of samples used by the user equipment for training the local model, so that an error of the global model trained by federated learning is minimized.

As an example, the training unit 103 may be configured to broadcast parameters related to the aggregated learning model (also referred to as an updated global model) of each group to user equipment in the group.

As an example, the training unit 103 may be configured to perform the division and the joint training repeatedly until a predetermined condition is satisfied. For example, the predetermined condition is that a predetermined number of iterations is reached, or an error of the aggregated learning model is less than a predetermined error, or the like.

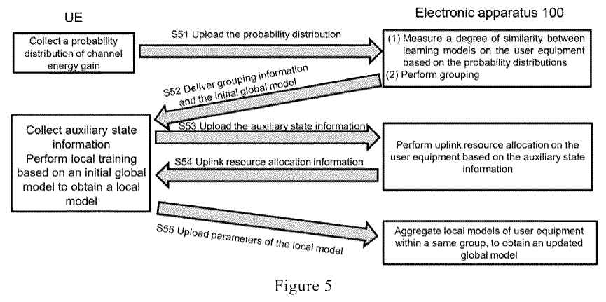

FIG. 5 is an example diagram illustrating information interaction between an electronic apparatus 100 and user equipment UE according to an embodiment of the present disclosure. In FIG. 5, the description is made by taking an example in which the channel information of the sidelink is a probability distribution of a channel energy gain of the sidelink.

A UE collects a probability distribution of a channel energy gain: Pᵢ=[pᵢ(h₁),pᵢ(h₂), . . . , pᵢ(h_{w})]. In S51, the UE uploads the collected probability distribution to the electronic apparatus 100.

The electronic apparatus 100 determines a degree of similarity of learning models of user equipment based on the probability distribution of the channel energy gain of the sidelink, and divides learning models having a high degree of similarity into a same group. In S52, the electronic apparatus 100 delivers grouping information and an initial global model to the UE.

In S53, the UE uploads the auxiliary state information to the electronic apparatus 100.

The electronic apparatus 100 perform the uplink resource allocation for the user equipment based on the auxiliary state information. For example, the electronic apparatus 100 finds user equipment having a Straggler problem and allocates more resources to such user equipment.

In S54, the electronic apparatus 100 delivers information of the uplink resource allocation to the UE.

The UE performs local training on the initial global model based on local sample data to obtain a local model.

In S55, the UE uploads parameters of the local model to the electronic apparatus 100 through the allocated uplink resource.

The electronic apparatus 100 aggregates local models of the user equipment in a same group to obtain an updated global model. The updated global model represents a final model of federated learning in the current training round, with a model error representing an effect of the current training round of federated learning.

The electronic apparatus 100 broadcasts the updated global model to all user equipment participating in the federated learning.

The training of federated learning requires the UE and the electronic apparatus 100 to perform several rounds of iteration and aggregation of the learning model, that is, to perform division and joint training repeatedly, that is, to perform the processing of S51 to S55 repeatedly until a predetermined condition is satisfied.

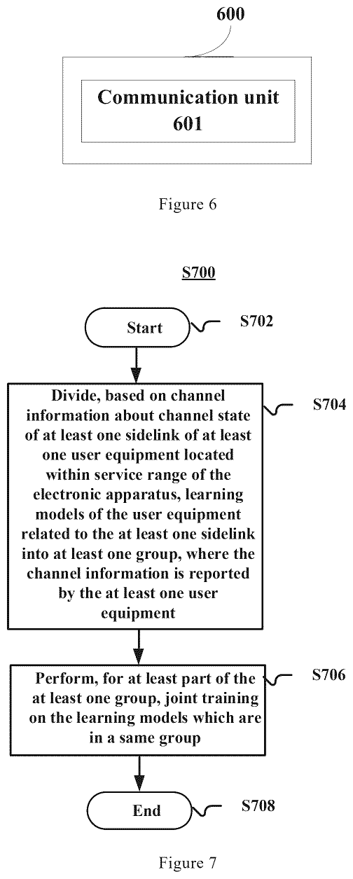

An electronic apparatus for wireless communication is further provided according to another embodiment of the present disclosure. FIG. 6 shows a block diagram of functional modules of an electronic apparatus 600 for wireless communication according to a further embodiment of the present disclosure.

As shown in FIG. 6, the electronic apparatus 600 includes a communication unit 601. The communication unit 601 may be configured to report, to a network-side apparatus serving the electronic apparatus 600, channel information about channel state of at least one sidelink of the electronic apparatus 600, for the network-side apparatus to: divide, based on the channel information, learning models of the electronic apparatus 600 related to the at least one sidelink and learning models of other electronic apparatuses served by the network-side apparatus and related to the at least one sidelink into at least one group, so as to perform, for at least part of the at least one group, joint training on the learning models which are in a same group.

The communication unit 601 may be implemented by one or more processing circuits. The processing circuitry may be implemented as a chip, for example.

The electronic apparatus 600 may, for example, be provided on user equipment (UE) side or be communicatively connected to the user equipment. In a case where the electronic apparatus 600 is provided on the user equipment side or communicatively connected to the user equipment, an apparatus related to the electronic apparatus 600 may be user equipment. Here, it should be noted that the electronic apparatus 600 may be implemented at a chip level or at an apparatus level. For example, the electronic apparatus 600 may operate as the user equipment itself and may further include a memory, a transceiver (not shown), and other external devices. The memory may store related data information and programs that the user equipment needs to execute to achieve various functions. The transceiver may include one or more communication interfaces to support communication with different devices (such as a base station, another UE, and the like). An implementation of the transceiver is not specifically limited here.

As an example, the network-side apparatus may be the electronic apparatus 100 mentioned above. As an example, the electronic apparatus 600 may be the user equipment involved in the above embodiments of the electronic apparatus 100.

The wireless communication system according to the present disclosure may be a 5G NR communication system. Further, the wireless communication system according to the present disclosure may include a non-terrestrial network. Alternatively, the wireless communication system according to the present disclosure may further include a terrestrial network. In addition, those skilled in the art can understand that the wireless communication system according to the present disclosure may be a 4G or 3G communication system.

In embodiments of the present disclosure, the electronic apparatus 600 reports the channel information about the channel state of the sidelink to the network-side apparatus, for the network-side apparatus grouping the learning models of the electronic apparatus 600 related to the sidelink based on the channel information. This helps the network-side apparatus solve a data heterogeneity problem caused by different environments of a sidelink through grouping, so that an efficiency of a joint training is improved, and a quality of learning models and a system performance are improved.

As an example, the channel information of the sidelink includes at least one of: a probability distribution of a channel energy gain of the sidelink, a Reference Signal Receiving Power (RSRP), a Received Signal Strength Indicator (RSSI), a Reference Signal Receiving Quality (RSRQ), a Signal-to-Noise Ratio (SNR), information about whether user equipment serving as a receiver and user equipment serving as a transmitter related to the sidelink are located within a line-of-sight range, and statistics of interference and noise of channel.

As an example, the network-side apparatus divides the leaning models based on a degree of similarity between probability distributions respectively corresponding to the at least one sidelink. For relevant examples of the division based on the degree of similarity between probability distributions of the channel energy gain of the sidelink, reference may be made to the description in conjunction with FIG. 3 in the embodiments of the electronic apparatus 100, which is not repeated here.

As an example, the degree of similarity between probability distributions includes a KL divergence between the probability distributions.

As an example, the channel energy gain is divided into a predetermined number of discrete levels, and the probability distribution includes probabilities that the channel energy gain is at respective levels. For details of the probabilities that the channel energy gain is at respective levels, reference may be made to the Pᵢ in the embodiment of the electronic apparatus 100, which is not repeated here.

As an example, the network-side apparatus divides the leaning models based on a magnitude of the RSRP.

As an example, the network-side apparatus divides the leaning models based on a magnitude of the RSSI.

As an example, the network-side apparatus divides the leaning models based on a magnitude of the RSRQ.

As an example, the network-side apparatus divides the leaning models based on a magnitude of the SNR.

As an example, the network-side apparatus divides the leaning models according to whether an electronic apparatus serving as a receiver and an electronic apparatus serving as a transmitter of the sidelink are located within a line-of-sight range.

As an example, the network-side apparatus divides the leaning models based on a magnitude of the statistics of interference and noise of channel.

As an example, the statistics of interference and noise of channel includes a mean and/or a variance.

As an example, the communication unit 601 may be configured to report the channel information via wireless resource control, RRC, signaling. For example, the RRC signaling may be MeasResultsSL signaling. For relevant examples of the MeasResultsSL, reference may be made to the description in the embodiments of the electronic apparatus 100, which is not repeated here.

As an example, the communication unit 601 may be configured to receive information about the division from the network-side apparatus via a physical downlink control channel (PDCCH).

As an example, the communication unit 601 may be configured to receive parameters related to an initial global learning model in a first round of the joint training.

As an example, the communication unit 601 may be configured to send auxiliary state information to the network-side apparatus via an uplink, where the auxiliary state information is for uplink resource allocation.

As an example, the auxiliary state information includes at least one of a quantity of samples used by the electronic apparatus 600 for training the learning models, location information of the electronic apparatus 600, moving speed of the electronic apparatus 600, computing capability of the electronic apparatus 600, and CPU occupancy rate of the electronic apparatus 600. For relevant examples of the auxiliary state information, reference may be made to the description in the embodiments of the electronic apparatus 100, which is not repeated here.

As an example, the communication unit 601 may be configured to receive information about uplink resource allocation from the network-side apparatus via a downlink.

As an example, the communication unit 601 may be configured to send parameters which are related to a local learning model to the network-side apparatus, based on the information about uplink resource allocation, where the local learning model is trained based on the initial global learning model issued by the network-side apparatus.

As an example, the joint training includes aggregating local learning models related to the sidelinks in a same group, as an updated global learning model, to obtain an aggregated learning model, and the communication unit 601 may be configured to receive parameters related to the aggregated learning model from the network-side apparatus.

As an example, the network-side apparatus performs the division and the joint training repeatedly until a predetermined condition is satisfied.

As an example, the learning model is for assisting in determining a data transmission rate of the sidelink based on a data queue length and a channel energy gain of the sidelink. For example, the learning model may be a deep reinforcement learning model involved in FIG. 3.

As an example, the electronic apparatus 600 is an apparatus in a D2D scenario. For example, the electronic apparatus 600 is a vehicle-mounted device in the Internet of Vehicles.

In the description of the electronic apparatuses for wireless communication in the above embodiments, some processes or methods are further disclosed. Hereinafter, an overview of the methods is given without repeating some of details discussed above. It should be noted that although disclosed in the description of the electronic apparatuses for wireless communication, the methods do not necessarily adopt the components as described or be performed by those components. For example, an embodiment of the electronic apparatus for wireless communication may be implemented partially or entirely using hardware and/or firmware, while a method for wireless communication discussed below may be implemented entirely by a computer-executable program, although the method may employ the hardware and/or firmware for the electronic apparatus for wireless communication.

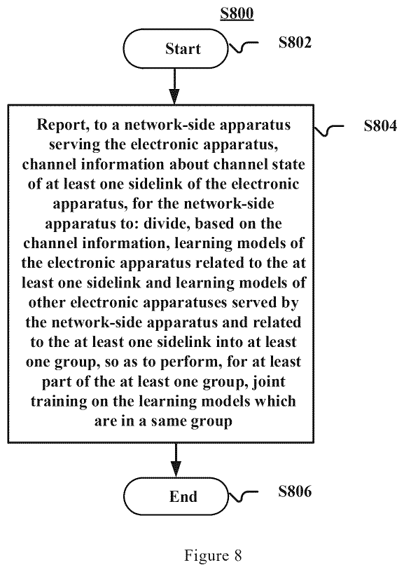

FIG. 7 shows a flow chart of a method S700 for wireless communication according to an embodiment of the present disclosure. The method S700 starts from step S702. In step S704, based on channel information about channel state of at least one sidelink of at least one user equipment located within service range of an electronic apparatus, learning models of the user equipment related to the at least one sidelink are divided into at least one group, where the channel information is reported by the at least one user equipment. In step S706, for at least part of the at least one group, joint training is performed on the learning models which are in a same group. The method S700 ends at step S708.

This method may be performed, for example, by the electronic apparatus 100 as described above. For specific details, reference may be made to the description of relevant processes of the electronic apparatus 100, which is not repeated here.

FIG. 8 shows a flow chart of a method S800 for wireless communication according to an embodiment of the present disclosure. The method S800 starts from step S802. In S804, channel information about channel state of at least one sidelink of an electronic apparatus is reported, to a network-side apparatus serving the electronic apparatus, for the network-side apparatus to: divide, based on the channel information, learning models of the electronic apparatus related to the at least one sidelink into at least one group, so as to perform, for at least part of the at least one group, joint training on the learning models which are in a same group. The method S800 ends at step S806.

This method may be performed, for example, by the electronic apparatus 600 as described above. For specific details, reference may be made to the description of relevant processes of the electronic apparatus 600, which is not repeated here.

The technology of the present disclosure can be applied to various products.

For example, the electronic apparatus 100 may be implemented as various network-side apparatuses, such as a base station. The base station may be implemented as any type of evolved Node B (eNB) or gNB (5G base station). An eNB includes, for example, a macro eNB and a small eNB. The small eNB may be an eNB covering a cell smaller than a macro cell, such as a pico eNB, a micro eNB, or a home (femto) eNB. A similar situation may apply to the gNB. Alternatively, the base station may be implemented as any other type of base station, such as a NodeB or a base transceiver station (BTS). The base station may include a body (which is also referred to as base station equipment) configured to control wireless communication and one or more remote radio heads (RRHs) arranged at a different place from the body. In addition, various types of user equipment can all operate as base stations by temporarily or semi-persistently performing base station functions.

The electronic apparatus 600 may be implemented as various user equipment. The user equipment may be implemented as a mobile terminal (such as a smart phone, a tablet personal computer (PC), a notebook PC, a portable game terminal, a portable/dongle-type mobile router, and a digital camera) or a vehicle-mounted terminal (such as an automobile navigation device). The user equipment may be implemented as a terminal that performs machine-to-machine (M2M) communication (which is also referred to as a machine type communication (MTC) terminal). Furthermore, the user equipment may be a wireless communication module (such as an integrated circuit module including a single chip) installed on each of the above-mentioned terminals.

### Application Examples of Base Station

### First Application Example

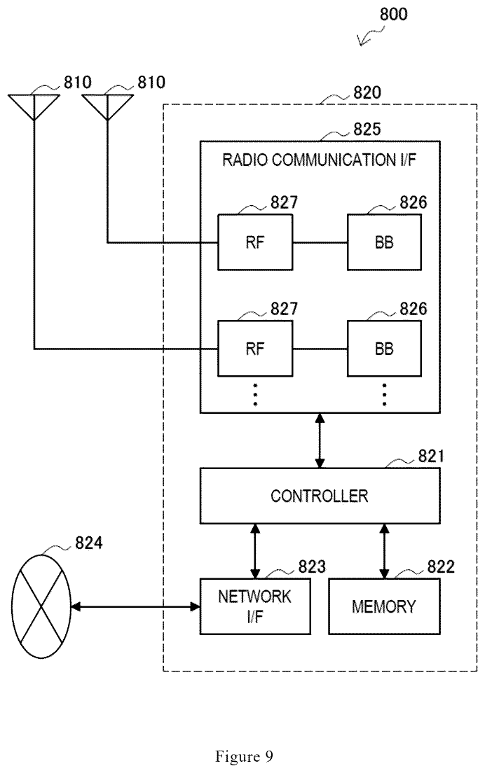

FIG. 9 is a block diagram showing a first example of a schematic configuration of an eNB or gNB to which the technology of the present disclosure can be applied. It should be noted that the following description is made taking an eNB as an example. The technology of the present disclosure is also applicable to a gNB. An eNB 800 includes one or more antennas 810 and base station equipment 820. The base station equipment 820 and each of the antennas 810 may be connected to each other via a RF cable.

Each of the antennas 810 includes a single or multiple antenna elements (such as multiple antenna elements included in a multi-input multi-output (MIMO) antenna), and is used for the base station equipment 820 to transmit and receive wireless signals. As shown in FIG. 9, the eNB 800 may include multiple antennas 810. For example, the multiple antennas 810 may be compatible with multiple frequency bands used by the eNB 800. Although FIG. 9 shows an example in which the eNB 800 includes multiple antennas 810, the eNB 800 may include a single antenna 810.

The base station equipment 820 includes a controller 821, a memory 822, a network interface 823, and a radio communication interface 825.

The controller 821 may be, for example, a CPU or DSP, and operates various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have logical functions of performing control such as radio resource control, radio bearer control, mobility management, admission control, and scheduling. The control may be performed in conjunction with a nearby eNB or a core network node. The memory 822 includes an RAM and an ROM, and stores a program executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or another eNB may be connected to each other through a logical interface (such as an SI interface and an X2 interface). The network interface 823 may be a wired communication interface or a radio communication interface for a wireless backhaul line. In a case that the network interface 823 is a radio communication interface, the network interface 823 may use a higher frequency band for wireless communication than a frequency band used by the radio communication interface 825.

The radio communication interface 825 supports any cellular communication scheme (such as Long-Term Evolution (LTE) and LTE-Advanced), and provides wireless connection to a terminal in a cell of the eNB 800 via the antenna 810. The radio communication interface 825 may typically include, for example, a baseband (BB) processor 826 and an RF circuit 87. The BB processor 826 may perform, for example, coding/decoding, modulation/demodulation and multiplexing/de-multiplexing, and perform various types of signal processes of layers (for example, layer 1, media access control (MAC), radio link control (RLC) and packet data convergence protocol (PDCP)). Instead of the controller 821, the BB processor 826 may have a part or all of the above-mentioned logical functions. The BB processor 826 may be a memory storing a communication control program, or a module including a processor and a related circuit configured to execute the program. Updating the program may change the functions of the BB processor 826. The module may be a card or blade inserted into a slot of the base station equipment 820. Alternatively, the module may be a chip mounted on the card or blade. In addition, the RF circuit 87 may include, for example, a mixer, a filter and an amplifier, and transmit and receive a wireless signal via the antenna 810.

As shown in FIG. 9, the radio communication interface 825 may include multiple BB processors 826. For example, the multiple BB processors 826 may be compatible with multiple frequency bands used by the eNB 800. As shown in FIG. 9, the radio communication interface 825 may include multiple RF circuits 87. For example, the multiple RF circuits 87 may be compatible with multiple antenna elements. Although FIG. 9 shows an example in which the radio communication interface 825 includes multiple BB processors 826 and multiple RF circuits 87, the radio communication interface 825 may include a single BB processor 826 or a single RF circuit 87.

In the eNB 800 as shown in FIG. 9, the electronic apparatus 100, when implemented as a base station, has a transceiver that may be implemented by the radio communication interface 825. At least a part of the functions may be implemented by the controller 821. For example, the controller 821 may perform the division and joint training by performing functions of the units in the electronic apparatus 100.

### Second Application Example

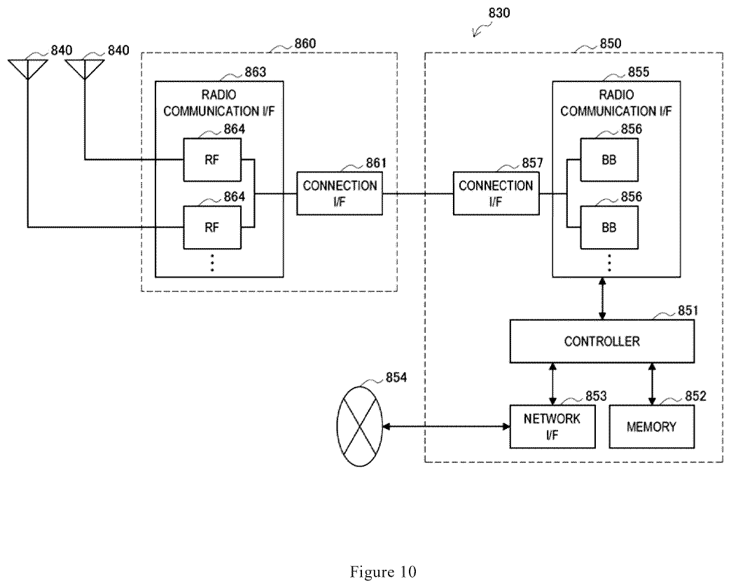

FIG. 10 is a block diagram showing a second example of a schematic configuration of an eNB or gNB to which the technology of the present disclosure can be applied. It should be noted that the following description is made taking the eNB as an example. The technology of the present disclosure is also applicable to the gNB. An eNB 830 includes a single or multiple antennas 840, base station equipment 850 and an RRH 860. The RRH 860 and each of the antennas 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna), and is used for the RRH 860 to transmit and receive a wireless signal. As shown in FIG. 10, the eNB 830 may include multiple antennas 840. For example, the multiple antennas 840 may be compatible with multiple frequency bands used by the eNB 830. Although FIG. 10 shows an example in which the eNB 830 includes multiple antennas 840, the eNB 830 may include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 9.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 9, except that the BB processor 856 is connected to an RF circuit 864 of the RRH 860 via the connection interface 857. As shown in FIG. 10, the radio communication interface 855 may include multiple BB processors 856. For example, the multiple BB processors 856 may be compatible with multiple frequency bands used by the eNB 830. Although FIG. 10 shows an example in which the radio communication interface 855 includes multiple BB processors 856, the radio communication interface 855 may include a single BB processor 856.

The connection interface 857 is an interface for connecting the base station equipment 850 (the radio communication interface 855) to the RRH 860. The connection interface 857 may be a communication module for communication in the above-described high-speed line that connects the base station equipment 850 (the radio communication interface 855) to the RRH 860.

The RRH 860 includes a connection interface 861 and a radio communication interface 863.

The connection interface 861 is an interface for connecting the RRH 860 (the radio communication interface 863) to the base station equipment 850. The connection interface 861 may also be a communication module for communication in the above-mentioned high-speed line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmit and receive wireless signals via the antenna 840. As shown in FIG. 10, the radio communication interface 863 may include multiple RF circuits 864. For example, the multiple RF circuits 864 may support multiple antenna elements. Although FIG. 10 shows an example in which the radio communication interface 863 includes multiple RF circuits 864, the radio communication interface 863 may include a single RF circuit 864.

In the eNB 830 as shown in FIG. 10, the electronic apparatus 100, when implemented as a base station, has a transceiver that may be implemented by the radio communication interface 855. At least a part of the functions may be implemented by the controller 851. For example, the controller 851 may perform the division and joint training by performing functions of the units in the electronic apparatus 100.

### Application Example of User Equipment

### First Application Example

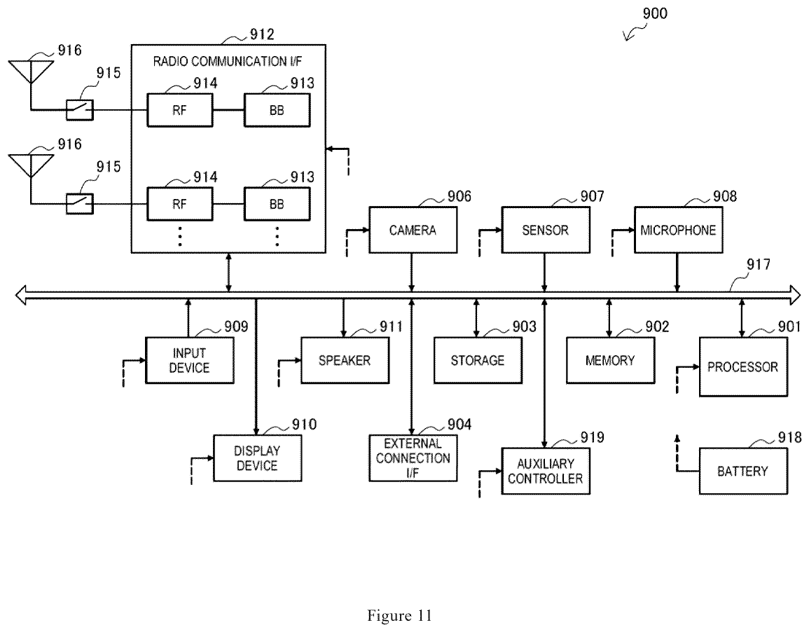

FIG. 11 is a block diagram showing an example of a schematic configuration of a smart phone 900 to which the technology of the present disclosure may be applied. The smart phone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls the functions of the application layer and other layers of the smart phone 900. The memory 902 includes an RAM and an ROM, and stores data and programs executed by the processor 901. The storage 903 may include a storage medium such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyroscope sensor, a geomagnetic sensor, and an acceleration sensor. The microphone 908 converts sound inputted to the smart phone 900 into an audio signal. The input device 909 includes, for example, a touch sensor configured to detect a touch on a screen of the display device 910, a keypad, a keyboard, a button, or a switch, and receives an operation or information inputted from a user. The display device 910 includes a screen, such as a liquid crystal display (LCD) or an organic light emitting diode (OLED) display, and displays an output image of the smart phone 900. The speaker 911 converts the audio signal outputted from the smart phone 900 into sound.

The radio communication interface 912 supports any cellular communication scheme (such as LTE and LTE-Advanced), and performs wireless communication. The radio communication interface 912 may generally include, for example, a BB processor 913 and an RF circuit 914. The BB processor 913 may perform, for example, encoding/decoding, modulation/demodulation, and multiplexing/demultiplexing, and perform various types of signal processing for wireless communication. In addition, the RF circuit 914 may include, for example, a mixer, a filter and an amplifier, and transmit and receive a wireless signal via the antenna 916. It should be noted that, although the figure shows a situation where one RF link is connected to one antenna, this is only illustrative, and a situation where one RF link is connected to multiple antennas through multiple phase shifters is also possible. The radio communication interface 912 may be a chip module on which the BB processor 913 and the RF circuit 914 are integrated. As shown in FIG. 11, the radio communication interface 912 may include multiple BB processors 913 and multiple RF circuits 914. Although FIG. 11 shows an example in which the radio communication interface 912 includes multiple BB processors 913 and multiple RF circuits 914, the radio communication interface 912 may include a single BB processor 913 or a single RF circuit 914.

In addition to the cellular communication scheme, the radio communication interface 912 may support another type of wireless communication scheme, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits (for example, circuits for different wireless communication schemes) included in the radio communication interface 912.

Each of the antennas 916 includes a single or multiple antenna elements (such as multiple antenna elements included in a MIMO antenna), and is configured for the radio communication interface 912 to transmit and receive wireless signals. As shown in FIG. 11, the smart phone 900 may include multiple antennas 916. Although FIG. 11 shows an example in which the smart phone 900 includes multiple antennas 916, the smart phone 900 may include a single antenna 916.

In addition, the smart phone 900 may include antenna(s) 916 for each wireless communication scheme. In this case, the antenna switches 915 may be omitted from the configuration of the smart phone 900.

The processor 901, the memory 902, the storage 903, the external connection interface 904, the camera 906, the sensor 907, the microphone 908, the input device 909, the display device 910, the speaker 911, the radio communication interface 912, and the auxiliary controller 919 are connected to each other via the bus 917. The battery 918 supplies power to each block of the smart phone 900 as shown in FIG. 11 via a feeder line. The feeder line is partially shown as a dashed line in the figure. The auxiliary controller 919 operates the least necessary function of the smart phone 900 in a sleep mode, for example.

In the smart phone 900 as shown in FIG. 11, in a case where the electronic apparatuses 600 is implemented, for example, as a smart phone on the user equipment side, the transceiver of the electronic apparatus 600 may be implemented by the radio communication interface 912. At least part of the functions may be implemented by the processor 901 or the auxiliary controller 919. For example, the processor 901 or the auxiliary controller 919 may report the channel information of the sidelink by performing the function of the unit in the electronic apparatus 600.

### Second Application Example

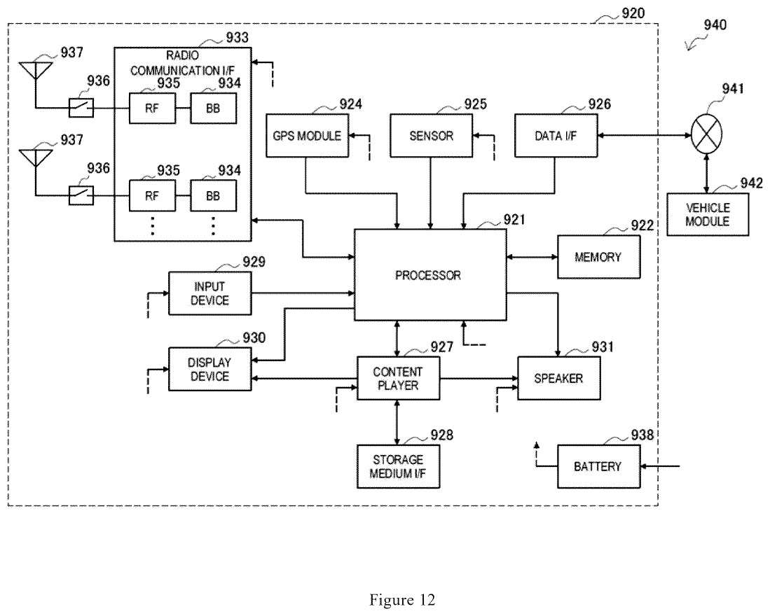

FIG. 12 is a block diagram showing an example of a schematic configuration of an automobile navigation device 920 to which the technology of the present disclosure may be applied. The automobile navigation device 920 includes a processor 921, a memory 922, a global positioning system (GPS) module 924, a sensor 925, a data interface 926, a content player 97, a storage medium interface 928, an input device 99, a display device 930, a speaker 931, a radio communication interface 913, one or more antenna switches 936, one or more antennas 937, and a battery 938.

The processor 921 may be, for example, a CPU or SoC, and controls the navigation function of the automobile navigation device 920 and other functions. The memory 922 includes an RAM and an ROM, and stores data and programs executed by the processor 921.

The GPS module 924 measures a position (such as latitude, longitude, and altitude) of the automobile navigation device 920 based on a GPS signal received from a GPS satellite. The sensor 925 may include a group of sensors, such as a gyroscope sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 97 reproduces content stored in a storage medium (such as a CD and a DVD) inserted into the storage medium interface 928. The input device 99 includes, for example, a touch sensor configured to detect a touch on a screen of the display device 930, a button, or a switch, and receives an operation or information inputted from the user. The display device 930 includes a screen such as an LCD or OLED display, and displays an image of a navigation function or reproduced content. The speaker 931 outputs a sound of the navigation function or the reproduced content.

The radio communication interface 913 supports any cellular communication scheme (such as LTE and LTE-Advanced), and performs wireless communication. The radio communication interface 913 may generally include, for example, a BB processor 934 and an RF circuit 935. The BB processor 934 may perform, for example, encoding/decoding, modulation/demodulation, and multiplexing/demultiplexing, and perform various types of signal processing for wireless communication. In addition, the RF circuit 935 may include, for example, a mixer, a filter and an amplifier, and transmit and receive a wireless signal via the antenna 937. The radio communication interface 913 may be a chip module on which the BB processor 934 and the RF circuit 935 are integrated. As shown in FIG. 12, the radio communication interface 913 may include multiple BB processors 934 and multiple RF circuits 935. Although FIG. 12 shows an example in which the radio communication interface 913 includes multiple BB processors 934 and multiple RF circuits 935, the radio communication interface 913 may include a single BB processor 934 or a single RF circuit 935.

In addition to the cellular communication scheme, the radio communication interface 913 may support another type of wireless communication scheme, such as a short-range wireless communication scheme, a near field communication scheme, or a wireless LAN scheme. In this case, the radio communication interface 913 may include a BB processor 934 and an RF circuit 935 for each wireless communication scheme.

Each of the antenna switches 936 switches a connection destination of the antenna 937 among multiple circuits (such as circuits for different wireless communication schemes) included in the radio communication interface 913.

Each of the antennas 937 includes a single or multiple antenna elements (such as multiple antenna elements included in a MIMO antenna), and is configured for the radio communication interface 913 to transmit and receive wireless signals. As shown in FIG. 12, the automobile navigation device 920 may include multiple antennas 937. Although FIG. 12 shows an example in which the automobile navigation device 920 includes multiple antennas 937, the automobile navigation device 920 may include a single antenna 937.

In addition, the automobile navigation device 920 may include antenna(s) 937 for each wireless communication scheme. In this case, the antenna switches 936 may be omitted from the configuration of the automobile navigation device 920.

The battery 938 supplies power to blocks of the automobile navigation device 920 shown in FIG. 12 via a feeder line. The feeder line is partially shown as a dashed line in the figure. The battery 938 accumulates electric power supplied from the vehicle.

In the automobile navigation device 920 as shown in FIG. 12, in a case where the electronic apparatuses 600 is implemented, for example, as an automobile navigation device on the user equipment side, the transceiver of the electronic apparatus 600 may be implemented by the radio communication interface 933. At least part of the functions may be implemented by the processor 921. For example, the processor 921 may report the channel information of the sidelink by performing the function of the unit in the electronic apparatus 600.

The technology of the present disclosure may also be implemented as an in-vehicle system (or vehicle) 940 including the vehicle navigation device 920, an in-vehicle network 941, and one or more blocks of vehicle modules 942. The vehicle modules 942 generate vehicle data (such as vehicle speed, engine speed, and failure information), and outputs the generated data to the in-vehicle network 941.

Basic principles of the present disclosure are described above in conjunction with the specific embodiments. However, it should be noted that those skilled in the art can understand that all or any of steps or components of the methods and apparatuses of the present disclosure can be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the methods according to the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

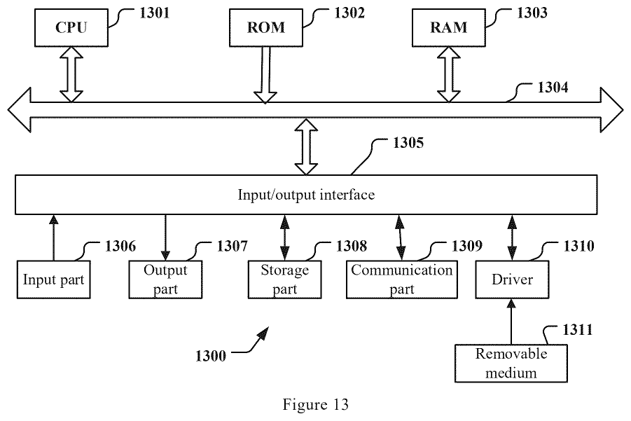

In a case of implementing the embodiments of the present disclosure in software or firmware, the program consisting of the software is mounted to a computer with a dedicated hardware structure (such as a general-purpose personal computer 1300 as shown in FIG. 13) from the storage medium or network. The computer, when mounted with various programs, performs various functions.

In FIG. 13, a central processing unit (CPU) 1301 executes various processes according to a program stored in a read-only memory (ROM) 1302 or a program loaded from a storage part 1308 to a random-access memory (RAM) 1303. In the RAM 1303, data required for the CPU 1301 to perform various processes or the like is stored as necessary. The CPU 1301, the ROM 1302 and the RAM 1303 are connected to each other via a bus 1304. An input/output interface 1305 is connected to the bus 1304.

The following components are connected to the input/output interface 1305: an input part 1306 (including a keyboard, a mouse, and the like), an output part 1307 (including a display, such as a cathode ray tube (CRT) and a liquid crystal display (LCD), a loudspeaker, and the like), a storage part 1308 (including a hard disk and the like), and a communication part 1309 (including a network interface card, such as a LAN card, and a modem). The communication part 1309 performs communication processing via a network, such as the Internet. A driver 1310 may be connected to the input/output interface 1305 as needed. A removable medium 1311, such as a magnetic disk, an optical disk, a magnetic optical disk, and a semiconductor memory, is mounted to the driver 1310 as required, so that a computer program read therefrom is mounted to the storage part 1308 as required.

In a case that the above processes are implemented by software, the program consisting of the software is mounted from a network, such as the Internet, or from a storage medium, such as the removable medium 1311.

Those skilled in the art should understood that, the storage medium is not limited to the removable medium 1311, as shown in FIG. 13, which stores a program and is distributed separately from the apparatus so as to provide the program for a user. Examples of the removable medium 1311 includes a magnetic disk (including a floppy disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 1302, the hard disk contained in the storage part 1308, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Finally, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) a (n) . . . ” does not exclude existence of other similar elements in the process, method, article or device.

Although the embodiments of the present disclosure are described in detail above with reference to the accompanying drawings, it should be understood that the embodiments are only for illustrating the present disclosure and do not constitute a limitation to the present disclosure. For those skilled in the art, various modifications and changes can be made to the embodiments without departing from the spirit and scope of the present disclosure. Therefore, the scope of the present disclosure is limited by only the appended claims and equivalents thereof.

The present technology may be implemented as the following solutions.

Solution 1. An electronic apparatus for wireless communication, comprising:
a processing circuitry configured to:
divide, based on channel information about channel state of at least one sidelink of at least one user equipment located within service range of the electronic apparatus, learning models of the user equipment related to the at least one sidelink into at least one group, wherein the channel information is reported by the at least one user equipment, and
perform, for at least part of the at least one group, joint training on the learning models which are in a same group.

Solution 2. The electronic apparatus according to solution 1, wherein
the channel information of the sidelink comprises at least one of: a probability distribution of a channel energy gain of the sidelink, a Reference Signal Receiving Power, RSRP, a Received Signal Strength Indicator, RSSI, a Reference Signal Receiving Quality, RSRQ, a Signal-to-Noise Ratio, SNR, information about whether user equipment serving as a receiver and user equipment serving as a transmitter related to the sidelink are located within a line-of-sight range, and statistics of interference and noise of channel.

Solution 3. The electronic apparatus according to solution 2, wherein
the processing circuitry is configured to divide the leaning models based on a degree of similarity between probability distributions respectively corresponding to the at least one sidelink.

Solution 4. The electronic apparatus according to solution 3, wherein
the degree of similarity comprises a KL divergence between the probability distributions.

Solution 5. The electronic apparatus according to any one of solutions 2 to 4, wherein
the channel energy gain is divided into a predetermined number of discrete levels, and the probability distribution comprises probabilities that the channel energy gain is at respective levels.

Solution 6. The electronic apparatus according to solution 2, wherein
the processing circuitry is configured to divide the leaning models based on a magnitude of the RSRP.

Solution 7. The electronic apparatus according to solution 2, wherein
the processing circuitry is configured to divide the leaning models based on a magnitude of the RSSI.

Solution 8. The electronic apparatus according to solution 2, wherein
the processing circuitry is configured to divide the leaning models based on a magnitude of the RSRQ.

Solution 9. The electronic apparatus according to solution 2, wherein
the processing circuitry is configured to divide the leaning models based on a magnitude of the SNR.

Solution 10. The electronic apparatus according to solution 2, wherein
the processing circuitry is configured to divide the leaning models according to whether the user equipment serving as a receiver and the user equipment serving as a transmitter of the sidelink are located within a line-of-sight range.

Solution 11. The electronic apparatus according to solution 2, wherein
the processing circuitry is configured to divide the leaning models based on a magnitude of the statistics of interference and noise of channel.

Solution 12. The electronic apparatus according to solution 11, wherein
the statistics of interference and noise of channel comprises a mean and/or a variance.

Solution 13. The electronic apparatus according to any one of solutions 1 to 12, wherein
the processing circuitry is configured to receive the channel information via wireless resource control, RRC, signaling.

Solution 14. The electronic apparatus according to any one of solutions 1 to 13, wherein
the processing circuitry is configured to send information about the division to at least part user equipment of the user equipment related to a sidelink in each group via a physical downlink control channel, PDCCH.

Solution 15. The electronic apparatus according to solution 14, wherein
the processing circuitry is configured to send parameters related to an initial global learning model to the at least part user equipment in a first round of the joint training.

Solution 16. The electronic apparatus according to solution 15, wherein
the processing circuitry is configured to receive auxiliary state information from the at least part user equipment via an uplink, wherein the auxiliary state information is for uplink resource allocation.

Solution 17. The electronic apparatus according to solution 16, wherein
the auxiliary state information comprises at least one of a quantity of samples used by the user equipment for training the learning models, location information of the user equipment, moving speed of the user equipment, computing capability of the user equipment, and CPU occupancy rate of the user equipment.

Solution 18. The electronic apparatus according to solution 16 or 17, wherein the processing circuitry is configured to perform the uplink resource allocation for the at least part user equipment based on the auxiliary state information.

Solution 19. The electronic apparatus according to solution 18, wherein the processing circuitry is configured to send information about uplink resource allocation to the at least part user equipment via a downlink.

Solution 20. The electronic apparatus according to solution 18 or 19, wherein the processing circuitry is configured to receive parameters which are related to a local learning model and which are uploaded by the at least part user equipment based on the information about uplink resource allocation, wherein the local learning model is trained based on the initial global learning model issued by the electronic apparatus.

Solution 21. The electronic apparatus according to solution 20, wherein
the joint training comprises aggregating local learning models related to sidelinks in a same group, to obtain an aggregated learning model as an updated global learning model, and
the processing circuitry is configured to broadcast parameters related to the aggregated learning model of each group to user equipment in the group.

Solution 22. The electronic apparatus according to any one of solutions 1 to 21, wherein the processing circuitry is configured to perform the division and the joint training repeatedly until a predetermined condition is satisfied.

Solution 23. The electronic apparatus according to any one of solutions 1 to 22, wherein
the learning model is for assisting in determining a data transmission rate of the sidelink based on a data queue length and a channel energy gain of the sidelink.

Solution 24. The electronic apparatus according to any one of solutions 1 to 23, wherein
the at least one user equipment is an apparatus in a D2D scenario.

Solution 25. An electronic apparatus for wireless communication, comprising:
a processing circuitry configured to:
report, to a network-side apparatus serving the electronic apparatus, channel information about channel state of at least one sidelink of the electronic apparatus, for the network-side apparatus to:
   divide, based on the channel information, learning models of the electronic apparatus related to the at least one sidelink and learning models of other electronic apparatuses served by the network-side apparatus and related to the at least one sidelink into at least one group, so as to perform, for at least part of the at least one group, joint training on the learning models which are in a same group.

Solution 26. The electronic apparatus according to solution 25, wherein
the channel information of the sidelink comprises at least one of: a probability distribution of a channel energy gain of the sidelink, a Reference Signal Receiving Power, RSRP, a Received Signal Strength Indicator, RSSI, a Reference Signal Receiving Quality, RSRQ, a Signal-to-Noise Ratio, SNR, information about whether user equipment serving as a receiver and user equipment serving as a transmitter related to the sidelink are located within a line-of-sight range, and statistics of interference and noise of channel.

Solution 27. The electronic apparatus according to solution 26, wherein
the network-side apparatus divides the leaning models based on a degree of similarity between probability distributions respectively corresponding to the at least one sidelink.

Solution 28. The electronic apparatus according to solution 27, wherein
the degree of similarity comprises a KL divergence between the probability distributions.

Solution 29. The electronic apparatus according to any one of solutions 26 to 28, wherein
the channel energy gain is divided into a predetermined number of discrete levels, and the probability distribution comprises probabilities that the channel energy gain is at respective levels.

Solution 30. The electronic apparatus according to solution 26, wherein
the network-side apparatus divides the leaning models based on a magnitude of the RSRP.

Solution 31. The electronic apparatus according to solution 26, wherein
the network-side apparatus divides the leaning models based on a magnitude of the RSSI.

Solution 32. The electronic apparatus according to solution 26, wherein
the network-side apparatus divides the leaning models based on a magnitude of the RSRQ.

Solution 33. The electronic apparatus according to solution 26, wherein
the network-side apparatus divides the leaning models based on a magnitude of the SNR.

Solution 34. The electronic apparatus according to solution 26, wherein
the network-side apparatus divides the leaning models according to whether an electronic apparatus serving as a receiver and an electronic apparatus serving as a transmitter of the sidelink are located within a line-of-sight range.

Solution 35. The electronic apparatus according to solution 26, wherein
the network-side apparatus divides the leaning models based on a magnitude of the statistics of interference and noise of channel.

Solution 36. The electronic apparatus according to solution 35, wherein
the statistics of interference and noise of channel comprises a mean and/or a variance.

Solution 37. The electronic apparatus according to any one of solutions 25 to 36, wherein
the processing circuitry is configured to report the channel information via wireless resource control, RRC, signaling.

Solution 38. The electronic apparatus according to any one of solutions 25 to 37, wherein
the processing circuitry is configured to receive information about the division from the network-side apparatus via a physical downlink control channel, PDCCH.

Solution 39. The electronic apparatus according to solution 38, wherein
the processing circuitry is configured to receive parameters related to an initial global learning model in a first round of the joint training.

Solution 40. The electronic apparatus according to solution 39, wherein
the processing circuitry is configured to send auxiliary state information to the network-side apparatus via an uplink, wherein the auxiliary state information is for uplink resource allocation.

Solution 41. The electronic apparatus according to solution 40, wherein
the auxiliary state information comprises at least one of a quantity of samples used by the electronic apparatus for training the learning models, location information of the electronic apparatus, moving speed of the electronic apparatus, computing capability of the electronic apparatus, and CPU occupancy rate of the electronic apparatus.

Solution 42. The electronic apparatus according to solution 40 or 41, wherein the processing circuitry is configured to receive information about uplink resource allocation from the network-side apparatus via a downlink.

Solution 43. The electronic apparatus according to solution 42, wherein the processing circuitry is configured to send parameters which are related to a local learning model to the network-side apparatus, based on the information about uplink resource allocation, wherein the local learning model is trained based on the initial global learning model issued by the network-side apparatus.

Solution 44. The electronic apparatus according to solution 43, wherein
the joint training comprises aggregating local learning models related to the sidelinks in a same group, as an updated global learning model, to obtain an aggregated learning model, and
the processing circuitry is configured to receive parameters related to the aggregated learning model from the network-side apparatus.

Solution 45. The electronic apparatus according to any one of solutions 25 to 44, wherein the network-side apparatus performs the division and the joint training repeatedly until a predetermined condition is satisfied.

Solution 46. The electronic apparatus according to any one of solutions 25 to 45, wherein
the learning model is for assisting in determining a data transmission rate of the sidelink based on a data queue length and a channel energy gain of the sidelink.

Solution 47. The electronic apparatus according to any one of solutions 25 to 46, wherein
the electronic apparatus is an apparatus in a D2D scenario.

Solution 48. A method for wireless communication, comprising:
dividing, based on channel information about channel state of at least one sidelink of at least one user equipment located within service range of an electronic apparatus, learning models of the user equipment related to the at least one sidelink into at least one group, wherein the channel information is reported by the at least one user equipment, and
performing, for at least part of the at least one group, joint training on the learning models which are in a same group.

Solution 49. A method for wireless communication, comprising:
reporting, to a network-side apparatus serving an electronic apparatus, channel information about channel state of at least one sidelink of the electronic apparatus, for the network-side apparatus to:
   divide, based on the channel information, learning models of the electronic apparatus related to the at least one sidelink and learning models of other electronic apparatuses served by the network-side apparatus and related to the at least one sidelink into at least one group, so as to perform, for at least part of the at least one group, joint training on the learning models which are in a same group.

Solution 50. A computer-readable storage medium having computer-executable instructions stored thereon that, when the computer-executable instructions are executed, perform the method for wireless communication according to solution 48 or 49.

1. An electronic apparatus for wireless communication, comprising:
at least one processor; and
at least one memory including computer program code, where the at least one memory and the computer program code are configured, with the at least one processor, to cause the electronic apparatus to at least:
divide, based on channel information about channel state of at least one sidelink of at least one user equipment located within service range of the electronic apparatus, learning models of the user equipment related to the at least one sidelink into at least one group, wherein the channel information is reported by the at least one user equipment, and
perform, for at least part of the at least one group, joint training on the learning models which are in a same group.

2. The electronic apparatus according to claim 1, wherein
the channel information of the sidelink comprises at least one of: a probability distribution of a channel energy gain of the sidelink, a Reference Signal Receiving Power, RSRP, a Received Signal Strength Indicator, RSSI, a Reference Signal Receiving Quality, RSRQ, a Signal-to-Noise Ratio, SNR, information about whether user equipment serving as a receiver and user equipment serving as a transmitter related to the sidelink are located within a line-of-sight range, and statistics of interference and noise of channel.

3. The electronic apparatus according to claim 2, wherein
the at least one memory and the computer program code are configured, with the at least one processor, to cause the electronic apparatus to divide the leaning models based on a degree of similarity between probability distributions respectively corresponding to the at least one sidelink.

4. The electronic apparatus according to claim 3, wherein
the degree of similarity comprises a KL divergence between the probability distributions.

5. The electronic apparatus according to claim 2, wherein
the channel energy gain is divided into a predetermined number of discrete levels, and the probability distribution comprises probabilities that the channel energy gain is at respective levels.

6. The electronic apparatus according to claim 2, wherein
the at least one memory and the computer program code are configured, with the at least one processor, to cause the electronic apparatus to:
divide the leaning models based on a magnitude of the RSRP, or
divide the leaning models based on a magnitude of the RSSI, or
divide the leaning models based on a magnitude of the RSRQ, or
divide the leaning models based on a magnitude of the SNR, or
divide the leaning models according to whether the user equipment serving as a receiver and the user equipment serving as a transmitter of the sidelink are located within a line-of-sight range, or
divide the leaning models based on a magnitude of the statistics of interference and noise of channel,
wherein
the statistics of interference and noise of channel comprises a mean and/or a variance.

7.-12. (canceled)

13. The electronic apparatus according to claim 1, wherein
the at least one memory and the computer program code are configured, with the at least one processor, to cause the electronic apparatus to receive the channel information via wireless resource control, RRC, signaling.

14. The electronic apparatus according to claim 1, wherein
the at least one memory and the computer program code are configured, with the at least one processor, to cause the electronic apparatus to send information about the division to at least part user equipment of the user equipment related to a sidelink in each group via a physical downlink control channel, PDCCH.

15. The electronic apparatus according to claim 14, wherein
the at least one memory and the computer program code are configured, with the at least one processor, to cause the electronic apparatus to send parameters related to an initial global learning model to the at least part user equipment in a first round of the joint training.

16. The electronic apparatus according to claim 15, wherein
the at least one memory and the computer program code are configured, with the at least one processor, to cause the electronic apparatus to receive auxiliary state information from the at least part user equipment via an uplink, wherein the auxiliary state information is for uplink resource allocation.

17. The electronic apparatus according to claim 16, wherein
the auxiliary state information comprises at least one of a quantity of samples used by the user equipment for training the learning models, location information of the user equipment, moving speed of the user equipment, computing capability of the user equipment, and CPU occupancy rate of the user equipment.

18. The electronic apparatus according to claim 16, wherein the at least one memory and the computer program code are configured, with the at least one processor, to cause the electronic apparatus to perform the uplink resource allocation for the at least part user equipment based on the auxiliary state information.

19. The electronic apparatus according to claim 18, wherein the at least one memory and the computer program code are configured, with the at least one processor, to cause the electronic apparatus to send information about uplink resource allocation to the at least part user equipment via a downlink.

20. The electronic apparatus according to claim 18, wherein the at least one memory and the computer program code are configured, with the at least one processor, to cause the electronic apparatus to receive parameters which are related to a local learning model and which are uploaded by the at least part user equipment based on the information about uplink resource allocation, wherein the local learning model is trained based on the initial global learning model issued by the electronic apparatus.

21. The electronic apparatus according to claim 20, wherein
the joint training comprises aggregating local learning models related to sidelinks in a same group, to obtain an aggregated learning model as an updated global learning model, and
the at least one memory and the computer program code are configured, with the at least one processor, to cause the electronic apparatus to broadcast parameters related to the aggregated learning model of each group to user equipment in the group.

22. The electronic apparatus according to claim 1, wherein the at least one memory and the computer program code are configured, with the at least one processor, to cause the electronic apparatus to perform the division and the joint training repeatedly until a predetermined condition is satisfied.

23. The electronic apparatus according to claim 1, wherein
the learning model is for assisting in determining a data transmission rate of the sidelink based on a data queue length and a channel energy gain of the sidelink.

24. The electronic apparatus according to claim 1, wherein
the at least one user equipment is an apparatus in a D2D scenario.

25. An electronic apparatus for wireless communication, comprising:
at least one processor; and
at least one memory including computer program code, where the at least one memory and the computer program code are configured, with the at least one processor, to cause the electronic apparatus to at least:
report, to a network-side apparatus serving the electronic apparatus, channel information about channel state of at least one sidelink of the electronic apparatus, for the network-side apparatus to:
divide, based on the channel information, learning models of the electronic apparatus related to the at least one sidelink and learning models of other electronic apparatuses served by the network-side apparatus and related to the at least one sidelink into at least one group, so as to perform, for at least part of the at least one group, joint training on the learning models which are in a same group.

26. The electronic apparatus according to claim 25, wherein
the channel information of the sidelink comprises at least one of: a probability distribution of a channel energy gain of the sidelink, a Reference Signal Receiving Power, RSRP, a Received Signal Strength Indicator, RSSI, a Reference Signal Receiving Quality, RSRQ, a Signal-to-Noise Ratio, SNR, information about whether user equipment serving as a receiver and user equipment serving as a transmitter related to the sidelink are located within a line-of-sight range, and statistics of interference and noise of channel.

27.-50. (canceled)
